(19) United States
(12) Patent Application Publication
(10) Pub. No.: US 2025/0052490 A1
(43) Pub. Date: Feb. 13, 2025

(54) POTABLE LIQUID COOLING DEVICE

(71) Applicants: Chad Richard Ritter, Bechtelsville, PA (US); Samuel Richard Ritter, Bechtelsville, PA (US)

(72) Inventors: Chad Richard Ritter, Bechtelsville, PA (US); Samuel Richard Ritter, Bechtelsville, PA (US)

(21) Appl. No.: 18/799,906

(22) Filed: Aug. 9, 2024

Related U.S. Application Data
(60) Provisional application No. 63/518,445, filed on Aug. 9, 2023.

(51) Int. Cl. F25D 31/00

(52) U.S. Cl. CPC F25D 31/002; F25D 2201/10; F25D 2331/806

(57) ABSTRACT

An improved beverage cooling device featuring a refrigeration source, a cold plate heat exchanger block, a track in contact with the cold plate heat exchanger block which directs liquid from the input to the output, and a removable top housing which seals the track during use of the device but may be removed to clean the sections of the device which contact the beverage to be cooled. In other embodiments, the invention additionally comprises a housing to contain and support the device, an exit valve allowing for a controlled release of the cooled beverage, or a top cap providing insulation and preventing contamination of the device.

### BACKGROUND OF THE INVENTION

Some beverages, such as coffee or tea, have to some consumers a high preferred temperature for preparation while those consumers prefer a low temperature for consumption, leading to the desire within the market for a device to quickly cool beverages. The field currently features heat exchanger beverage coolers which utilize enclosed pipes through which the beverage passes. The enclosed nature of the pipes utilized in the prior art increases the difficulty of cleaning those devices. The field also features open track cooling devices, where beverages pass over ice, which lack the ability to be reused, sealed, or easily cleaned, or the ability to prevent the exit of the beverage after passing through the device.

### SUMMARY OF THE INVENTION

What is presented is an improved potable liquid cooling device. This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

In at least one embodiment of the invention, there exists a refrigeration source 2, such as a condenser, a cold plate heat exchanger block 4, a track 6, and a top housing 8. The refrigeration source 2 is thermally connected to the cold plate heat exchanger block 4, upon which sits the track 6, which repeatedly traverses the width of the cold plate heat exchanger block 4, from the track input 14 to the track output 16. The track 6 has a downward slope along its length, directing fluid from the input 14 to the output 16. The track 6 is composed of thermally conductive material, aiding in heat transfer from the fluid to the track 6 and from the track 6 to the cold plate heat exchanger block 4. The track 6 has a bottom 18 and side walls 20, on top of which the top housing 8 can be attached, forming a seal between the track 6 and the top housing base 24. The top housing 8 can also be removed from the device, allowing access to the interior of the track 6 to facilitate cleaning.

In at least one embodiment, the apparatus further comprises a main housing 12 which forms a bottom and walls of the device and provides structural support to the device.

In at least one embodiment, the apparatus further comprises an exit valve 10 connected to the track output 16, which can be closed to allow the retention of the fluid within the device or opened to allow exit of the fluid from the device.

In at least one embodiment, the apparatus further comprises a top cap 22 which can be placed over the track input to provide insulation and aid in maintaining the cleanliness of the track 6.

In at least one embodiment, the apparatus further comprises a top housing with an insulating layer 28.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings of which:

FIG. 1 depicts a cross-sectional view of one embodiment of the claimed invention, identifying various components;

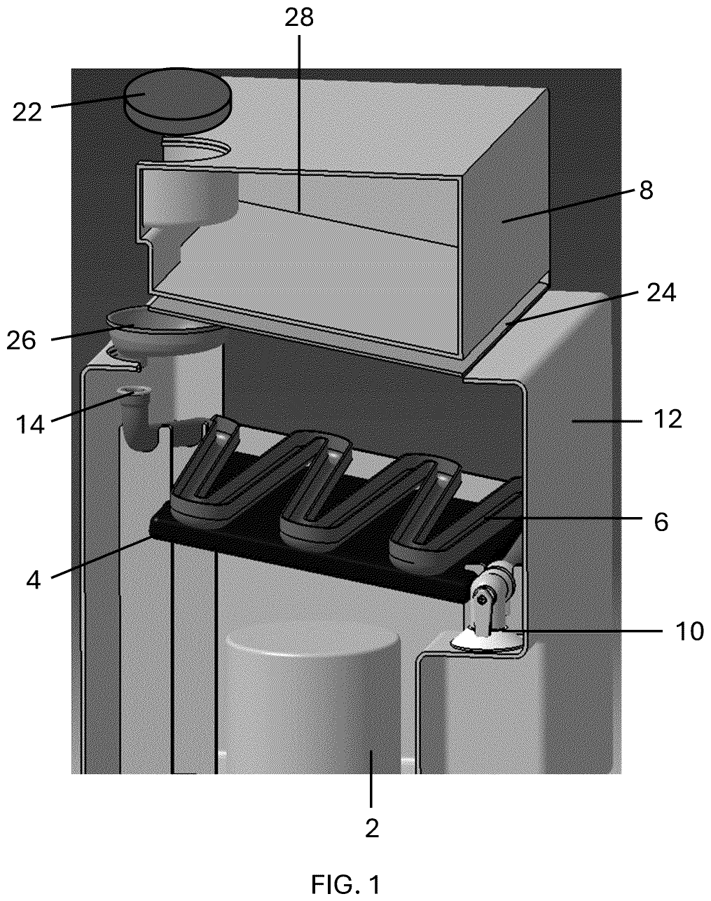

FIG. 2 depicts a close-up view of the track of the device, identifying various components;

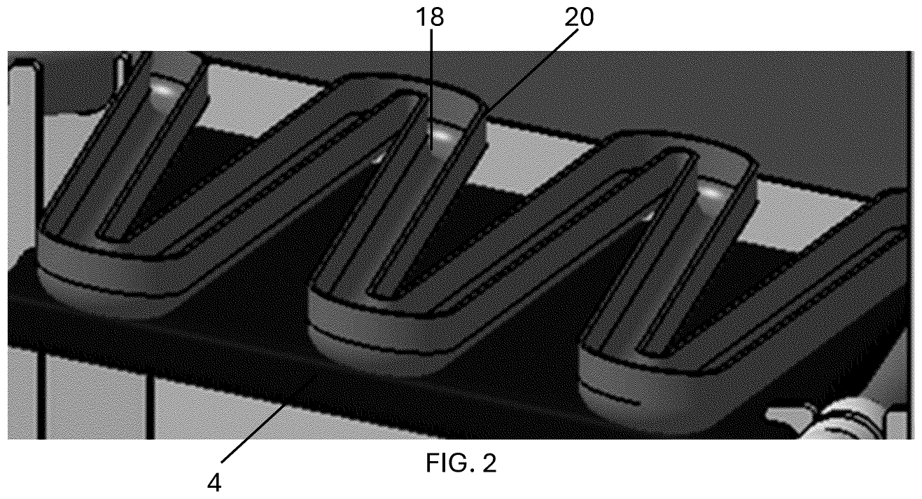

FIG. 3 depicts a cross-sectional view of one configuration of the claimed invention where the top housing is attached to the track forming a seal;

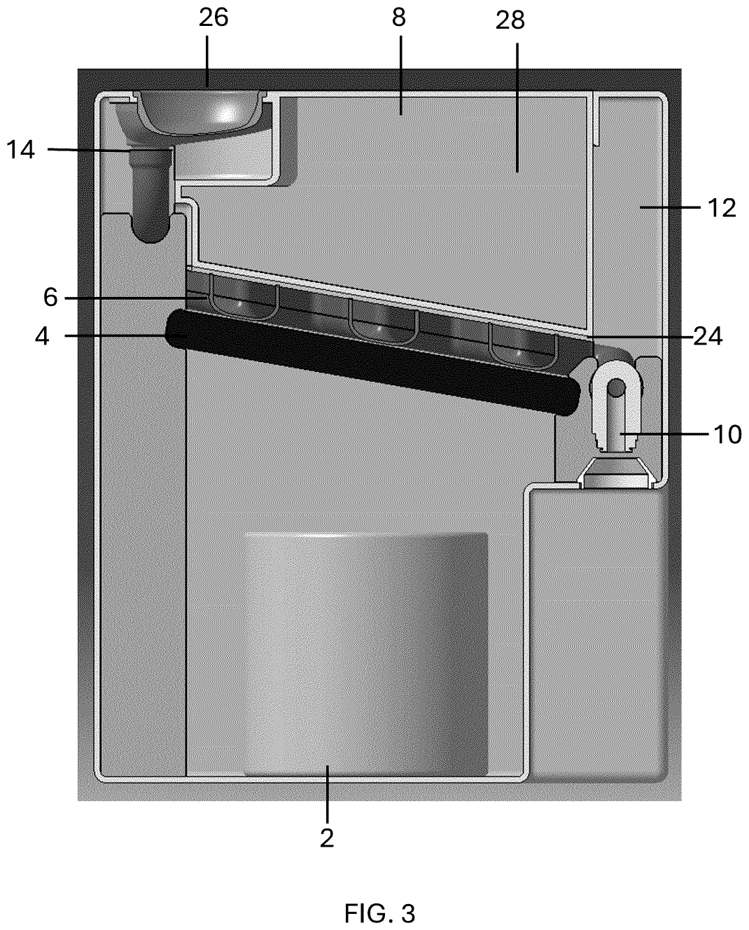

FIG. 4 depicts a top-down view of one configuration of the claimed invention where the top housing is removed;

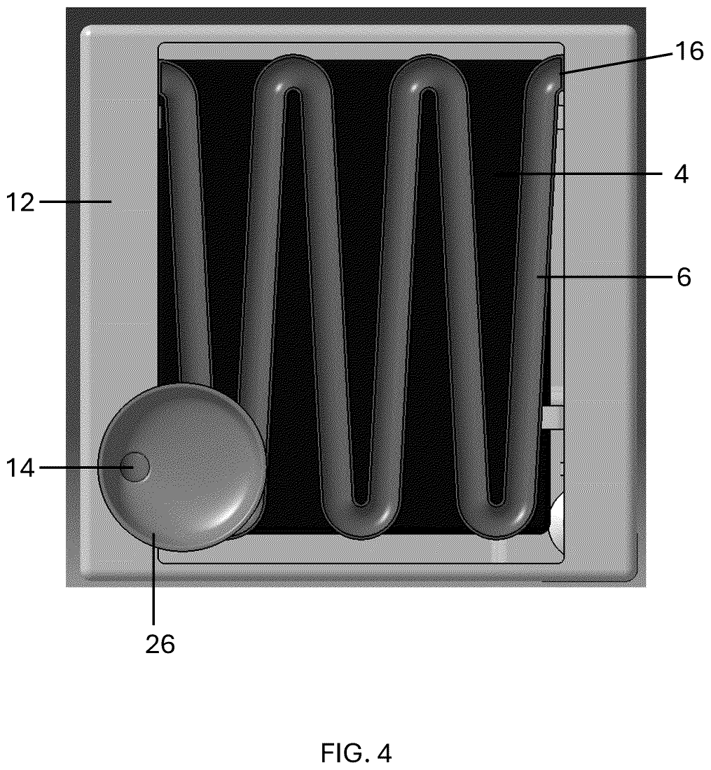

FIG. 5 depicts one configuration of the invention where the top housing is attached.

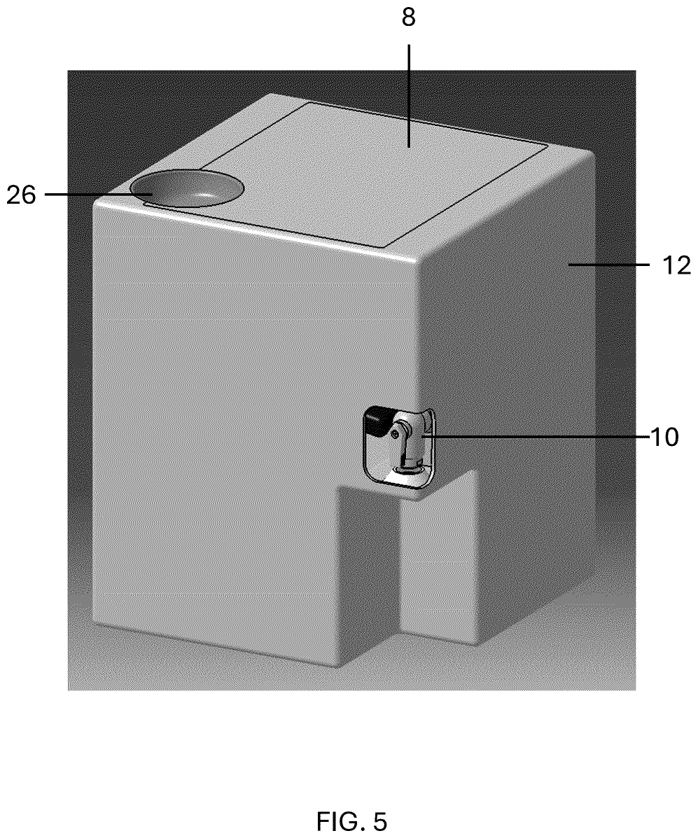

### DETAILED DESCRIPTION OF THE INVENTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

What is presented is an improved potable liquid cooling device. This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

In at least one embodiment of the invention, there exists a refrigeration source 2, such as a condenser, a cold plate heat exchanger block 4, a track 6, and a top housing 8. The refrigeration source 2 is thermally connected to the cold plate heat exchanger block 4, upon which sits the track 6, which repeatedly traverses the width of the cold plate heat exchanger block 4, from the track input 14 to the track output 16. The track 6 has a downward slope along its length, directing fluid from the input 14 to the output 16. The track 6 is composed of thermally conductive material, aiding in heat transfer from the fluid to the track 6 and from the track 6 to the cold plate heat exchanger block 4. The track 6 has a bottom 18 and side walls 20, on top of which the top housing 8 can be attached, forming a seal between the track 6 and the top housing base 24. The top housing 8 can also be removed from the device, allowing access to the interior of the track 6 to facilitate cleaning.

In at least one embodiment, the apparatus further comprises a main housing 12 which forms a bottom and walls of the device and provides structural support to the device.

In at least one embodiment, the apparatus further comprises an exit valve 10 connected to the track output 16, which can be closed to allow the retention of the fluid within the device or opened to allow exit of the fluid from the device.

In at least one embodiment, the apparatus further comprises a top cap 22 which can be placed over the track input to provide insulation and aid in maintaining the cleanliness of the track 6.

In at least one embodiment, the invention may be used by activating the refrigeration source 2 to cool the cold plate heat exchanger block 4 and track 6, attaching the top housing 8 to the track, pouring a beverage into the track input 14, with the possible aid of a funnel 26, and collecting the cooled beverage from the track output 16. The user may then remove the top housing 8 allowing the user to clean the inside of the track 6 and the top housing base 24.

In at least one embodiment, the user collects cooled beverage from the opened exit valve 10.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. An improved beverage cooling apparatus comprising:
a refrigeration source;
a cold plate heat exchanger block thermally connected to said refrigeration source, wherein said refrigeration source cools said cold plate heat exchanger block;
a track composed of thermally conductive material, having an input and an output, in contact with said cold plate heat exchanger block which traverses a serpentine path across said cold plate heat exchanger block, such that at all points along the length of said track, said track has a downward slope, wherein said cold plate heat exchanger block cools said track, and wherein all liquid deposited at said input passes along said track from said input to said output; and
a top housing which can be attached to said track to form a seal to contain liquid within said track during use, or removed to facilitate cleaning of said track.

2. The improved beverage cooling apparatus of claim 1 further comprising a main housing forming a bottom and walls for the improved beverage cooling apparatus.

3. The improved beverage cooling apparatus of claim 1 further comprising an exit valve connected to said output which can be set either to allow fluid from the track to exit the improved beverage cooling apparatus or contain said fluid within the improved beverage cooling apparatus.

4. The improved beverage cooling apparatus of claim 1 further comprising a top cap which is placed over said input, whereby the insulation for the improved beverage cooling apparatus is improved.

5. The improved beverage cooling apparatus of claim 1 further comprising said top housing having an insulating layer.
